(19) United States
(12) Patent Application Publication
(10) Pub. No.: US 2013/0060622 A1
(43) Pub. Date: Mar. 7, 2013

(54) Electronic wallet coupon redemption method

(71) Applicants: Kevin J. Kail, Orlando, FL (US); Jason Kummerl, Warren, MI (US)

(72) Inventors: Kevin J. Kail, Orlando, FL (US); Jason Kummerl, Warren, MI (US)

(73) Assignee: epcSolutions Inc.

(21) Appl. No.: 13/573,054

(22) Filed: Aug. 17, 2012

Related U.S. Application Data
(60) Provisional application No. 61/573,047, filed on Aug. 17, 2011.

(51) Int. Cl. G06Q 30/02

(52) U.S. Cl. 705/14.26

(57) ABSTRACT

A method for preventing fraudulent use of electronic coupons, discount certificates, and similar opportunities in mobile electronic commerce. Once a user has received an opportunity via the user's mobile device, the coupon, certificate, etc. may be redeemed. Redemption mechanisms may include a bar code which appears on the screen of the mobile device which is simply scanned at the point-of-sale or an alphanumeric code may be sent which the clerk types into her register. Thereafter, the user hands his device to the cashier, retailer, etc. whereupon the cashier undertakes the necessary actions to complete the process, for example, by selecting a “redeem” option appearing on the screen and entering a code.

### RELATED APPLICATIONS

This is a utility application claiming benefit and priority from U.S. Provisional Application Ser. No. 61/573,047 filed Aug. 17, 2011.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

1. Field of the Invention

The present invention generally relates to electronic commerce, more particularly, electronic commerce facilitated via mobile devices, for example, a so-called “smart” mobile handset. Specifically, the invention is an easy to use, secure electronic wallet, including an electronic coupon system which facilitates secure use of electronic coupons to users having a mobile device, for example a “smart” mobile handset. Embodiments contemplate the use of, but are not limited to, electronic coupons and their redemption, electronic marketing, and fraud prevention strategies therein.

2. Background of the Invention

Using coupons offering a discount for services or goods is a common and long-held business practice dating to at least the 19^{th} century and quite possibly much earlier. Such coupons were typically printed on paper and included the name of the product(s) and the discount value or discount rate. Retail customers using such coupons presented them to a sales clerk at the time of purchase and a discount or other promotional strategy was applied at the point-of-sale.

More recently, advances in data communications have led to the development of systems enabling delivery of an electronic coupon, discount certificates, gift certificates, and the like to a mobile device, such as a so-called “smart” mobile handset. These handsets generally include a screen large enough to display a bar code or similar indicia which may be used for the delivery and tracking of these coupons/certificates. Generally, these systems display the value of the discount on the screen of the device, which the user shows to the sales clerk who then enters the discount amount.

When paper coupons are used, the seller, typically a retail store, must collect and tabulate all coupons received from the customer, report the coupon total to the product manufacturer, retailer, service provider, and the like, and bill for the total discounted amount of the coupons. This method is time consuming and labor intensive.

In contrast electronic coupons/certificates are generally easier to distribute and are more readily used but lack security. Because it is difficult to authenticate the coupons and/or prevent their re-use, fraud is rampant. False or otherwise counterfeit coupons can be electronically generated, duplicated, and distributed, thereby costing brand owners millions of dollars annually. In the case of one leading beverage manufacturer, false five dollar ($5.00) coupons were created and redeemed across the United States although no such coupons were available in print or electronic media. Another local business utilized a “deal of the day” type group coupon service, which generates serialized deal coupons which users tender at the register. Fraudulent coupons for this small business subsequently caused it to suffer significant losses. Nationally, one large provider of group coupons is known to experience a fraud rate of approximately 15%-20% despite significant precautions. In addition to the outright fraud described above, issues include instances wherein a single party acquires and uses multiple coupons/certificates despite an imposed limitation of only one coupon per user. Similarly, a single coupon may be used multiple times, either by the same party or passed around to acquaintances. Moreover, it can be difficult to determine who used the coupon with the result that the coupon may be used by unintended parties or alternatively, targeted users may in fact be availing themselves of multiple discounts by using coupons intended for others. From the manufacturer's, service provider's, or retailer's standpoint, this lack of granularity with regard to who is using a particular coupon is a waste of resources that may otherwise be used more efficiently. More importantly, actually knowing when, where, how, and by whom a coupon is used can generate a wealth of data that may later be used to better focus marketing strategies, business plans, product lines, and the like.

Electronic coupons, discount certificates, and the like are distributed to mobile devices in a number of ways. Users may simply subscribe to receive such offers via a brand owner's website or other communications medium, either as a free service or by paid subscription. Brand owners include retailers and manufacturers, as well as service providers, for example, group coupon operations. Increasingly more common are models wherein an affinity algorithm is able to match products to a particular consumer according to, for example, previous queries about the specific item or items like it, bar code scans, RFID tag scans, product reviews submitted by the user/consumer, or social network friends, purchase history, gifting history, wish lists, and the like. The opportunities, whether they be an electronic coupon, discount certificate, or the like, are by their nature highly configurable. The coupon opportunity may be made available only during a specific time period or on specific days. Additionally, the opportunities may be used to test different marketing strategies. Offers may be split tested wherein groups are offered one of several concurrent opportunities. For example, the brand owner may elect to make available either a free add-on or a discount, which is forwarded to a randomly selected half of their identified users. Thereafter, the more successful offer can subsequently be promulgated or further refined as desired.

What is needed, therefore, is a method, apparatus, or data structure wherein fraudulent use of electronic coupons, discount certificates, and the like may be prevented. Ideally, the method will entail a level of verification at the time of redemption such that counterfeit or duplicate use is prevented and use only by the authorized user is assured. Moreover, the method will generate demographic information that may subsequently be used to better target merchandise, merchandising opportunities, and potential consumers.

### SUMMARY OF THE INVENTION

The present invention contemplates that once a user has received an opportunity via his or her mobile device and the virtual wallet contained therein, the coupon, certificate, etc. may be used in much the same way as its paper counterpart. It may be immediately discarded or alternatively, the user may avail himself or herself of the coupon opportunity so that, particularly with regard to affinity type marketing situations where the user oftentimes is literally standing in front of the product, the user can elect to purchase the product on the spot. More commonly, the user will elect to simply save the opportunity in his or her virtual wallet for possible later use.

Multiple redemption mechanisms are contemplated under the invention and include a bar code which appears on the screen of the mobile device which is simply scanned at the point-of-sale. Alternatively, an alphanumeric code may be sent which the clerk simply types into the clerk's register. Such mechanisms are well known to those skilled in the art and the improvements herein generally comprise methods to ensure against fraud and to enable enhanced data acquisition as described above. To complete redemption, the user simply hands his or her smartphone or equivalent device to the cashier, retailer, etc. whereupon the cashier undertakes the necessary actions to complete the process, for example, by selecting a “redeem” option appearing on the screen and entering a code. It will be understood by those skilled in the art that equivalent redemption schema are known, for example swiping the employee badge at the point-of-sale terminal, reading a pre-programmed NFC tag, entering a code using either a physical keyboard or a simulated keyboard presented via a touchscreen, reading a one- or two-dimensional barcode, or the like.

It is an object of the invention to provide fraud resistant electronic coupons, discount certificates, gift certificates, and the like;

It is a further object of the invention to enable enhanced customer data acquisition; It is yet another object of this invention to ensure electronic coupons, discount certificates, gift certificates, and the like are redeemed by the intended user;

It is still another object of this invention to ensure electronic coupons, discount certificates, gift certificates, and the like are not re-used; and,

It is an object of this invention to facilitate marketing research via electronic coupons, discount certificates, gift certificates, and the like.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a schematic flowchart of the present invention.

### DETAILED DESCRIPTION OF THE INVENTION

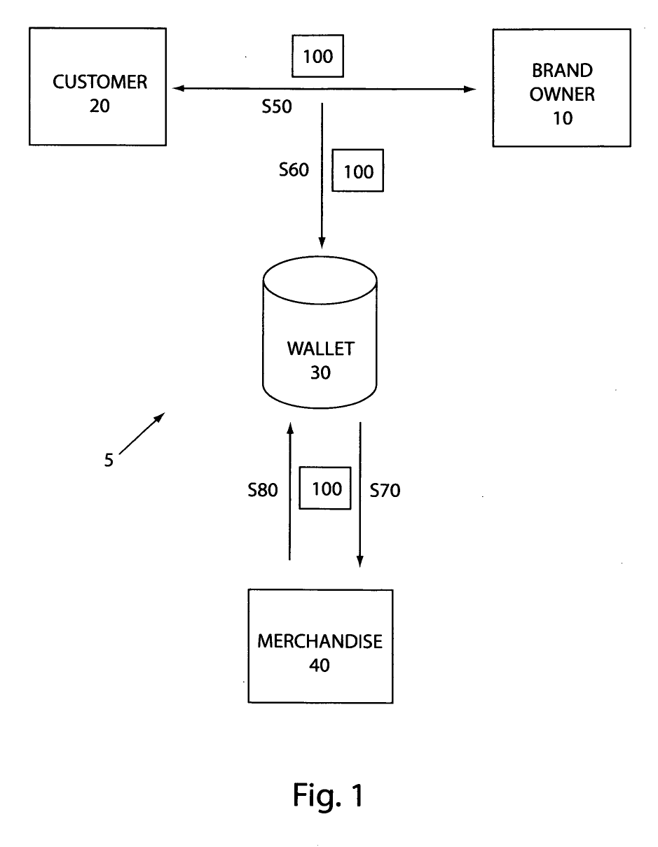

The preferred embodiment and best mode of the invention is shown in FIG. 1. While the invention is described in connection with this preferred embodiment, it is not intended that the present invention be so limited. On the contrary, it is intended to cover all alternatives, modifications, and equivalent arrangements as may be included within the spirit and scope of the invention as defined by the appended claims.

Turning to FIG. 1, the method of the present invention generally commences with an opportunity 100 for acquisition of goods or services in the form of an electronic coupon, discount certificate, gift certificate, or the like being made available S50. The brand owner 10 may publish the opportunity 100 via the mass media or alternatively, may target particular customers 20 according to a particular affinity, for example previous queries by the customer 20 about a particular or similar items using an account linked to the customer's mobile device or via the mobile device itself, bar code scans using the customer's mobile device; RFID tag scans; product reviews submitted by the customer 20; the customer's social network friends; purchase history; gifting history; wish lists; and the like. Similarly, the customer 20 may elect to subscribe to offers via the company's website or other communications medium in order to receive the opportunity 100. Thereafter, an award S60 of the opportunity 100 occurs by an electronic coupon, discount certificate, gift certificate, or the like which is accepted by the customer 20 into his or her virtual wallet 30. Upon the election of the customer 20, redemption S70 of the opportunity 100 occurs wherein, as described in greater detail supra, a barcode appearing on the screen of the mobile device is scanned, an alphanumeric code entered, or similar operation occurs as will be understood by those skilled in the art. Thereafter, removal S80 of the opportunity 100 occurs in an essentially contemporaneous process whereby, the customer 20 having handed his or her mobile device to the cashier, retailer, etc., the cashier or retailer undertakes the necessary actions to complete the process, for example, by selecting a “redeem” option appearing on the screen and entering a code whereby the merchandise and/or services 40 are presented to the customer 20. As noted above, it is understood by those skilled in the art that redemption schema are known, for example swiping an employee badge at the point-of-sale terminal, reading a pre-programmed NFC terminal, reading a pre-programmed NFC tag, entering a code using either a physical keyboard or a simulated keyboard presented via a touchscreen, reading a one- or two-dimensional barcode, or the like.

At this time, the method of the present invention determines that the opportunity 100 has been redeemed or used and will no longer present the opportunity 100 to the customer 20 for use either by deleting, blocking or invalidating that specific opportunity to the specific user. This information is synchronized to the customer's 20 wallet information stored on the network. The enhanced customer data acquired during the redemption may be used by the brand owner 10 for refining or otherwise better targeting its marketing efforts, for example, by identifying the demographic information of customers 20 who were most receptive to the opportunity 100, the date, time, or place redemption occurs, and the other desired marketing data.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What we claim is:

1) A method for eliminating fraud in mobile commerce electronic marketing opportunities comprising the steps of:
a) transmitting the availability of a mobile commerce electronic marketing to a potential customer for a specific opportunity;
b) accepting said specific opportunity by said potential customer;
c) electing to redeem said specific opportunity by said potential customer;
d) validating said specific opportunity by a receiving party; and,
e) removing said specific opportunity from additional use by said potential customer.

2) A method for eliminating fraud in mobile commerce electronic marketing opportunities as claimed in claim 1 wherein in step b), a potential customer accepting said opportunity further comprises a potential customer accepting said opportunity on the customer's mobile device.

3) A method for eliminating fraud in mobile commerce electronic marketing opportunities as claimed in claim 1 wherein in step d), validating said opportunity further comprises said redeeming party entering a code on a mobile device

4) A method for eliminating fraud in mobile commerce electronic marketing opportunities as claimed in claim 1 wherein in step d), validating said opportunity further comprises said redeeming party swiping an employee badge at the point-of-sale terminal, reading a pre-programmed NFC tag, entering a code using a physical keyboard, entering a code using a simulated keyboard presented via a touchscreen, or reading a one- or two-dimensional barcode

5) A method for eliminating fraud in mobile commerce electronic marketing opportunities comprising the steps of:
a) indicating the availability of a mobile commerce electronic marketing opportunity to a potential customer on his or her mobile device;
b) accepting said opportunity by said potential customer on said potential customer's mobile device;
c) electing redemption of said opportunity by said potential customer; and,
d) validating redemption of said opportunity by a redeeming party.

6) A method for eliminating fraud in mobile commerce electronic marketing opportunities as claimed in claim 5 further comprising the step of:
e) removing said opportunity from use of a redeeming customer.

7) A method for eliminating fraud in mobile commerce electronic marketing opportunities as claimed in claim 5 wherein in step d), validating said opportunity further comprises said redeeming party entering a code on said mobile device

8) A method for eliminating fraud in mobile commerce electronic marketing opportunities as claimed in claim 5 wherein in step d), validating said opportunity further comprises said redeeming party swiping an employee badge at the point-of-sale terminal.

9) A method for eliminating fraud in mobile commerce electronic marketing opportunities as claimed in claim 5 wherein in step d), validating said opportunity further comprises said redeeming party reading a pre-programmed NFC tag.

10) A method for eliminating fraud in mobile commerce electronic marketing opportunities as claimed in claim 5 wherein in step d), validating said oppOrtunity further comprises said redeeming party entering a code using a physical keyboard.

11) A method for eliminating fraud in mobile commerce electronic marketing opportunities as claimed in claim 5 wherein in step d), validating said opportunity further comprises said redeeming party entering a code using a simulated keyboard presented via a touchscreen.

12) A method for eliminating fraud in mobile commerce electronic marketing opportunities as claimed in claim 5 wherein in step d), validating said opportunity further comprises said redeeming party reading a one- or two-dimensional barcode.

13) A method for eliminating fraud in mobile commerce electronic marketing opportunities comprising the steps of:
a) indicating the availability of a mobile commerce electronic marketing opportunity to a Potential customer on his or her mobile device;
b) accepting said opportunity by said potential customer on said potential customer's mobile device;
c) electing redemption of said opportunity by said potential customer;
d) validating redemption of said opportunity by a redeeming party; and,
e) removing said opportunity from use of a redeeming customer.

14) A method for eliminating fraud in mobile commerce electronic marketing opportunities as claimed in claim 13 wherein in step d), validating said opportunity further comprises said redeeming party entering a code on said mobile device

15) A method for eliminating fraud in mobile commerce electronic marketing opportunities as claimed in claim 13 wherein in step d), validating said opportunity further comprises said redeeming party swiping an employee badge at the point-of-sale terminal.

16) A method for eliminating fraud in mobile commerce electronic marketing opportunities as claimed in claim 13 wherein in step d), validating said opportunity further comprises said redeeming party reading a pre-programmed NFC tag.

17) A method for eliminating fraud in mobile commerce electronic marketing opportunities as claimed in claim 13 wherein in step d), validating said opportunity further comprises said redeeming party entering a code using a physical keyboard.

18) A method for eliminating fraud in mobile commerce electronic marketing opportunities as claimed in claim 13 wherein in step d), validating said opportunity further comprises said redeeming party entering a code using a simulated keyboard presented via a touchscreen.

19) A method for eliminating fraud in mobile commerce electronic marketing opportunities as claimed in claim 13 wherein in step d), validating said opportunity further comprises said redeeming party reading a one- or two-dimensional barcode.
